(19) United States
(12) Patent Application Publication
(10) Pub. No.: US 2009/0319120 A1
(43) Pub. Date: Dec. 24, 2009

(54) VEHICLE STEERING ANGLE SENSOR

(75) Inventors: Shinji HATANAKA, Okazaki-city (JP); Kenji Takeda, Okazaki-city (JP); Shigetoshi Fukaya, Toyota-city (JP)

Correspondence Address: NIXON & VANDERHYE, PC, 901 NORTH GLEBE ROAD, 11TH FLOOR, ARLINGTON, VA, 22203, US

(73) Assignees: NIPPON SOKEN, INC., Nishio-city (JP); DENSO CORPORATION, Kariya-city (JP)

(21) Appl. No.: 12/486,275

(22) Filed: Jun. 17, 2009

(30) Foreign Application Priority Data
Jun. 20, 2008 (JP) 2008-161318

(51) Int. Cl. G06F 7/00

(52) U.S. Cl. 701/34

(57) ABSTRACT

A steering angle sensor includes a magnetized body coupled through a gear to a steering shaft so as to rotate with rotation of the steering shaft, a magnetic sensing device for detecting a magnetic field generated by the magnetized body, a signal processing device for detecting a direction of the magnetic field based on the detected magnetic field and for detecting a steering angle of the steering shaft based on the direction of the magnetic field, a correlation signal output sensor mounted on the vehicle to output a correlation signal correlated with the steering angle, and a signal check circuit for determining whether the steering angle is valid or invalid based on comparison between the steering angle and the correlation signal.

### CROSS REFERENCE TO RELATED APPLICATION

This application is based on and incorporates herein by reference Japanese Patent Application No. 2008-161318 filed on Jun. 20, 2008.

### FIELD OF THE INVENTION

The present invention relates to improvement of a vehicle steering angle sensor.

### BACKGROUND OF THE INVENTION

A steering angle sensor has been provided that detects a vehicle steering angle for steering torque assist. A steering angle sensor generally includes a driven gear engaged with a drive gear fixed to a steering shaft, a magnetized rotating body rotating with the driven gear, a magnetic sensing device for detecting a direction of a magnetic flux generated by the magnetized rotating body, a circuit section for detecting a steering angle based on the detected magnetic flux direction. For steering angle detection, it is required to detect a steering shaft angle greater than 360 degrees. Therefore, the steering shaft and the magnetized rotating body are mechanically coupled together through a gear mechanism.

In such a conventional steering angle sensor, if poor engagement between the drive and driven gears occurs due to, for example, chipped teeth of gears, the steering angle sensor may not accurately detect a steering angle.

In a rotation angle sensor disclosed in JP-A-2004-361212, magnetic sensing devices and gears are configured in a redundant manner. In such an approach, even if one gear has chipped teeth, a rotation angle can be normally detected.

Therefore, the rotation angle sensor can have an improved reliability. However, due to the redundant configuration, the rotation angle sensor is increased in manufacturing cost and complexity in structure. Further, the rotation angle sensor requires large accommodation space near a steering shaft and is thus increased in size. Furthermore, although the magnetic sensing devices and gears are configured in a redundant manner, other portions such as the magnetized rotating body are not configured in a redundant manner. A failure in the other portions may cause an error in the detected rotation angle.

### SUMMARY OF THE INVENTION

In view of the above, it is an object of the present invention to provide a vehicle steering angle sensor for providing an improved detection reliability without increasing size and complexity in structure.

According to an aspect of the present invention, a vehicle steering angle sensor for detecting a steering angle of a steering shaft of a vehicle includes a magnetized body, a magnetic sensing device, a signal processing device, a correlation signal output sensor, and a signal check circuit. The magnetized body provides a magnetic circuit with a gap and is coupled through a gear to the steering shaft so as to rotate on a magnet rotation axis in conjunction with rotation of the steering shaft. The magnetic sensing device is located on the magnet rotation axis to detect a magnetic field generated by the magnetized body. The magnetic sensing device outputs a magnetic field signal indicative of the magnetic field. The signal processing device detects a direction of the magnetic field based on the magnetic field signal and detects the steering angle based on the direction of the magnetic field. The signal processing device outputs a steering angle signal indicative of the steering angle. The correlation signal output sensor is mounted on the vehicle to output a correlation signal correlated with the steering angle signal. The signal check circuit determines whether the steering angle signal is valid or invalid based on comparison between the steering angle signal and the correlation signal.

The signal check circuit preferably can detect a failure of the steering angle sensor, when the steering angle signal is determined invalid at least once for a predetermined continuous period of time.

The signal check circuit preferably can detect the failure of the steering angle sensor, when the steering angle signal is determined invalid twice or more times for the predetermined continuous period of time.

The signal check circuit preferably can generate an alarm indicative of the failure of the steering angle sensor upon detection of the failure of the steering angle sensor.

The correlation signal output sensor preferably can include at least one of a steering torque sensor for detecting a steering torque of the vehicle, a rotation angular velocity sensor for detecting a rotational angular velocity of the vehicle, and a wheel speed sensor for detecting a wheel speed of the vehicle.

### BRIEF DESCRIPTION OF THE DRAWINGS

The above and other objectives, features and advantages of the present invention will become more apparent from the following detailed description made with check to the accompanying drawings. In the drawings:

FIG. 1 is a diagram illustrating a cross-sectional view of a vehicle steering angle sensor according to an embodiment of the present invention;

FIG. 2 is a diagram illustrating a top view of a yoke and a pair of semi-cylindrical magnets held in the yoke of the steering angle sensor;

FIG. 3 is a diagram illustrating a x-direction component and a y-direction component of a magnetic flux density;

FIG. 4 is a block diagram of the steering angle sensor;

FIG. 5 is a flow diagram illustrating a routine performed by a signal processing section of the steering angle sensor;

FIG. 6A is a diagram illustrating a correlation between a steering angle θs and a rotational angular velocity ωv in a case where the steering angle sensor is normal, and FIG. 6B is a diagram illustrating a correlation between a steering angle θs and a rotational angular velocity ωv in a case where the steering angle sensor is in failure;

FIG. 7 is a diagram illustrating a correlation between a steering angle θs and a wheel speed difference Δωw between left and right wheel speeds ωw; and

FIG. 8 is a block diagram of a vehicle steering angle sensor according to a modification of the embodiment.

### DETAILED DESCRIPTION OF THE PREFERRED EMBODIMENT

(Structure of a Steering Angle Sensor)

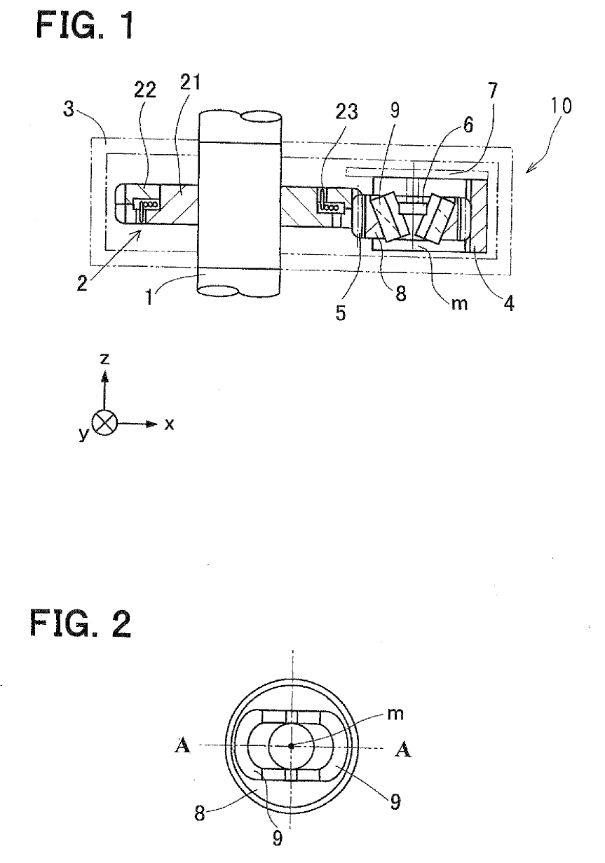

A vehicle steering angle sensor 10 according to an embodiment of the present invention is described below with reference to FIGS. 1 and 2. FIG. 1 is a diagram illustrating a cross-sectional view of the steering angle sensor 10 along its axis, and FIG. 2 is a diagram illustrating a top view of a yoke 8 and a pair of semi-cylindrical magnets 9 of the steering angle sensor 10 when viewed from a top side of FIG. 1 in a direction of a magnetic rotation axis m.

The steering angle sensor 10 is a sensor for detecting a rotation angle of a rotating body 1 that serves as a steering shaft of a vehicle. A drive gear 2 is fixed to the rotating body 1. The rotating body 1 extends to penetrate a housing 3. A screw receiver 4 is fixed to an inner surface of the housing 3. A driven gear 5 is engaged with each of the drive gear 2 and the screw receiver 4 A magnetic sensing device 6 is hung from the housing 3 on an axis M (i.e., a magnet rotation axis) of the driven gear 5. In the embodiment, the axis M of the driven gear 5 coincides with the magnetic rotation axis m. A printed circuit board 7 includes a signal processing section 100. The signal processing section 100 has a signal check circuit, which is described later.

For example, the drive gear 2 is constructed with a scissors gear, which is a so-called non-backlash gear. Alternatively, the drive gear 2 can be constructed with a gear other than a scissors gear.

A female screw surface is formed on an inner surface of the screw receiver 4. The screw receiver 4 has a semi-cylindrical shape that is formed by cutting a cylinder with a female screw surface inside by a predetermined angle width in its axis direction.

The driven gear 5 is located between the rotating body 1 and the screw receiver 4. The axis M of the driven gear 5 is located on an imaginary line that connects an axis of the rotating body 1 and a circumferential center of the screw receiver 4. The driven gear 5 is engaged with the drive gear 2. Further, a tip of the driven gear 5 has a male screw surface engaged with the female screw surface of the screw receiver 4. The driven gear 5 is located on an inner bottom of the housing 3 and allowed to rotate freely.

The yoke 8 has a tube shape and made of soft iron. The yoke 8 is fixed to an inner circumferential surface of the driven gear 5. The pair of semi-cylindrical magnets 9 is inserted into the yoke 8 and thus fixed to an inner circumferential surface of the yoke 8. The semi-cylindrical magnets 9 are circumferentially spaced from each other by 180 degrees. As shown in FIG. 2, the inner circumferential surface of the yoke 8 has a shape to follow outer circumferential shape of the semi-cylindrical magnets 9 so that the semi-cylindrical magnets 9 can be tightly fitted inside the yoke 8. Alternatively, the inner circumferential surface of the yoke 8 can have a shape other than the shape shown in FIG. 2, as long as the inner circumferential surface of the yoke 8 can surround the entire periphery of the magnetic sensing device 6 while providing magnetic short-circuit between the outer circumferential surfaces of the semi-cylindrical magnets 9. Further, the pair of semi-cylindrical magnets 9 can be replaced with a single cylindrical permanent magnet having an inner circumferential surface shaped like a cone.

The pair of semi-cylindrical magnets 9 is fixed to the yoke 8 in a inclined position so that its bottom end can be located closer to the magnet rotation axis m than its top end in a direction of the magnet rotation axis m. The pair of semi-cylindrical magnets 9 has a uniform thickness in its radial direction. Specifically, the pair of semi-cylindrical magnets 9 has a shape that is formed by cutting a cylindrical magnet by an occupied angle 2α from its axis in parallel to its axis. In the embodiment, the driven gear 5 and the yoke 8 are formed as separate pieces and then assembled together. Alternatively, the driven gear 5 and the yoke 8 can be integrally formed with each other.

As shown in FIG. 2, the pair of semi-cylindrical magnets 9 is magnetized in a direction (A-A direction in FIG. 2) of a cross-section taken along its radial direction so that inner surfaces of the semi-cylindrical magnets 9 have opposite magnetic polarities. Specifically, in FIG. 2, the inner surface of the upper semi-cylindrical magnet 9 becomes a south pole surface, and the inner surface of the lower semi-cylindrical magnet 9 becomes a north pole surface. Therefore, a magnetic flux B in the A-A direction is formed on the axis M in a direction perpendicular to the axis M. The yoke 8 magnetically short-circuits between the outer circumferential surfaces of the semi-cylindrical magnets 9 and also acts as a shield to stop external electric field as noise.

The magnetic sensing device 6 is located on the axis M and includes first and second Hall elements. The magnetic sensing device 6 can include peripheral circuits such as amplifier circuits for amplifying outputs of the first and second Hall elements. The first Hall element detects a magnetic flux density component Bx in a x-direction of FIG. 1 and produces a voltage signal Vx corresponding to the x-direction magnetic flux density component Bx. The second Hall element detects a magnetic flux density component By in a y-direction and produces a voltage signal Vy corresponding to the y-direction magnetic flux density component By. Each of the x-direction and y-directions is perpendicular to the axis M. The magnetic flux B generated by the pair of semi-cylindrical magnets 9 on the axis M is equal to the vector sum of the magnetic flux densities components By, Bx.

(Operation of a Steering Angle Sensor)

A rotation angle detection operation of the steering angle sensor 10 is described below.

When the drive gear 2 rotates with the rotating body 1, the driven gear 5 engaged with the drive gear 2 rotates. Since the driven gear 5 is also engaged with the screw receiver 4, the driven gear 5 moves along its axis while rotating. When the rotating body 1 rotates, the pair of magnetic surfaces (i.e., north and south pole surfaces) rotates so that a distance between the pair of magnetic surfaces and the magnetic sensing device 6 in the radial direction of the pair of semi-cylindrical magnets 9 continuously changes with rotation of the rotating body 1. Accordingly, a direction and a magnitude of a magnetic field (i.e., magnetic flux) penetrating the magnetic sensing device 6 in the radial direction continuously change with rotation of the rotating body 1.

The x-direction magnetic flux density component Bx and the y-direction magnetic flux density component By of the magnetic flux B acting on the magnetic sensing device 6 are given by:

Bx=f(θ)·cosθ (1)

By=f(θ)·sinθ (2)

In the above equations (1), (2), θ represents a rotation angle of the pair of semi-cylindrical magnets 9 with respect to the direction A-A, and f(θ) represents a function value indicating a change of the length of a vector of the magnetic flux B due to movement of the pair of semi-cylindrical magnets 9 in the axis direction. The function value f(θ) is determined depending on shapes and materials of the yoke 8 and the pair of semi-cylindrical magnets 9. The signal processing section 100 stores a relationship between the function value f(θ) and the number of rotations of the pair of semi-cylindrical magnets 9 about the magnet rotation axis m.

The signal processing section 100 calculates the arctangent of (By/Bx). As a result of the arctangent calculation, the following equation is obtained: θ1=arctan(By/Bx). Further, the signal processing section 100 calculates the square root of the sum of squares of the x-direction magnetic flux density component Bx and the y-direction magnetic flux density component By, thereby calculating the vector length of the magnetic flux B. The number of rotations of the pair of semi-cylindrical magnets 9 is calculated from the relationship stored in the signal processing section 100 using the function value f(θ), which represents the vector length of the magnetic flux B. That is, in the embodiment, the number of rotations of the pair of semi-cylindrical magnets 9 from a reference point is calculated from the function value f(θ), the current rotation angle θ1 of the pair of semi-cylindrical magnets 9 within one rotation is calculated from the arctangent of (By/Bx), and the final rotation angle θ of the pair of semi-cylindrical magnets 9 greater than or equal to 360 degrees is calculated from the calculated number of rotations and the calculated current rotation angle θ1. For example, when the number of rotations is one, and the current rotation angle θ1 is 55 degrees, the final rotation angle θ becomes 415 degrees (i.e., 360+45 degrees).

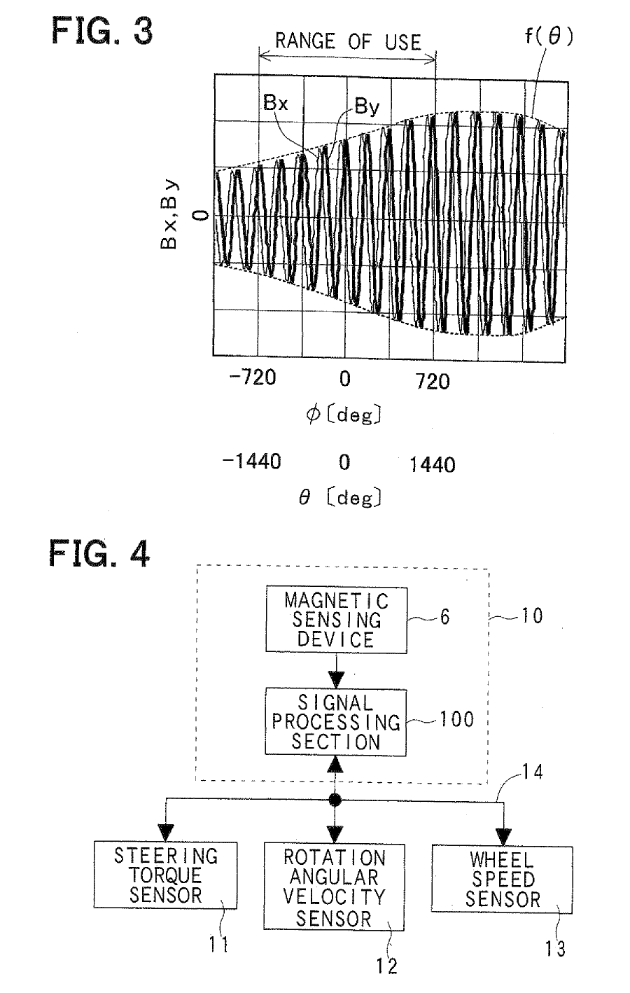

FIG. 3 is a diagram illustrating relationships between the final rotational angle θ of the pair of semi-cylindrical magnets 9, a rotation angle Θ of the rotating body 1, the x-direction magnetic flux density component Bx on the magnetic sensing device 6, and the y-direction magnetic flux density component By on the magnetic sensing device 6. In the embodiment, the pair of semi-cylindrical magnets 9 moves in the axis direction while rotating. Therefore, as shown in FIG. 3, a rotation angle greater than or equal to 360 degrees can be detecting by using one set of a magnetic rotating assembly.

(Additional Structure for a Steering Angle Sensor)

An additional structure for the steering angle sensor 10 is described below with reference to FIG. 4.

As shown in FIG. 4, the steering angle sensor 10 includes the magnetic sensing device 6 and the signal processing section 100 that performs signal processing on an output signal of the magnetic sensing device 6. Specifically, the signal processing section 100 includes an analog calculator for performing signal processing on the output signal of the magnetic sensing device 6, an analog-to-digital (A/D) converter for converting an output signal of the analog calculator to a digital signal, and a microcomputer for performing signal processing on the digital signal. In this way, the signal processing section 100 calculates a steering angle of the vehicle by detecting a rotation angle of the rotating body 1 based on the output signal of the magnetic sensing device 6.

The signal processing section 100 receives detection signals from a steering torque sensor 11, a vehicle rotation angular velocity sensor 12, and a vehicle wheel speed sensor (i.e., vehicle speed sensor) 13 via a signal transmission line 14. The steering torque sensor 11 detects a steering torque Ts. The rotation angular velocity sensor 12 is a so-called yaw rate sensor or gyro sensor and detects a rotational angular velocity ωv of the vehicle. The vehicle wheel speed sensor 13 detects a wheel speed ωw of each wheel by detecting a rotational angle of each wheel. Typically, these sensors 11-13 are originally mounted on the vehicle.

(Operation of a Signal Check Circuit)

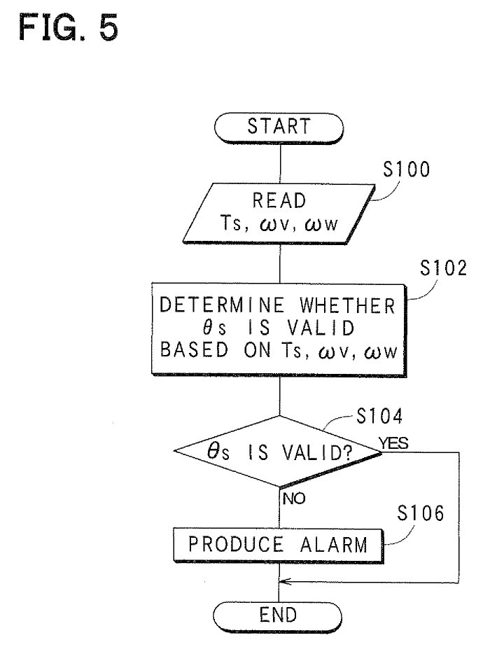

The signal processing section 100 can serve as a signal check circuit by performing a routine shown in a flow diagram of FIG. 5.

The routine starts at S100, where the signal processing section 100 reads the steering torque Ts from the steering torque sensor 11, the rotational angular velocity ωv from the rotation angular velocity sensor 12, and the wheel speed ωw. Then, the routine proceeds to S102, where the signal processing section 100 determines whether a steering angle θs calculated from the output signal of the magnetic sensing device 6 is within a predetermined normal range based on the steering torque Ts, the rotational angular velocity ωv, and the wheel speed ωw. The steering angle θs is considered valid, the steering angle θs is within the predetermined normal range. In contrast, the steering angle θs is considered invalid, the steering angle θs is outside the predetermined normal range. If the steering angle θs is considered valid corresponding to YES at S104, the routine ends by skipping S106. In contrast, if the steering angle θs is considered invalid corresponding to NO at S104, the routine proceeds to S106, where the signal processing section 100 outputs an alarm. Then, the routine ends.

The steering torque Ts, the rotational angular velocity ωv, and the wheel speed ωw are described in derail below.

The present inventors have found that the steering angle θs has a continuous correlation with each of the steering torque Ts, the rotational angular velocity ωv, and the wheel speed ωw.

For example, the steering torque Ts has a positive correlation with an acceleration of the steering angle θs and increases with an in increase in the acceleration of the steering angle θs in a region where the steering angle θs is large. Specifically, a steering load torque having a magnitude equal to that of the steering torque Ts and a direction opposite to that of the steering torque Ts has a component proportional to the acceleration that is derived by double-differentiating the steering angle θs. Further, in a condition where a difference in the tire pointing direction and the vehicle traveling direction is large, the steering load torque becomes large due to an increase in surface resistance. Therefore, the steering torque Ts has a strong positive correlation with the steering angle θs.

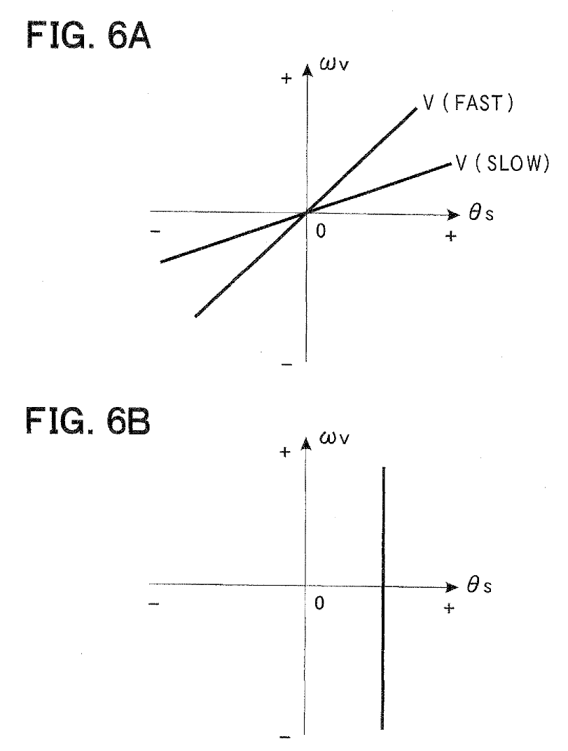

FIGS. 6A and 6B illustrate relationships between the steering angle θs, the rotational angular velocity ωv, and a vehicle speed V. FIG. 6A illustrates a case where the steering angle sensor 10 is normal, and FIG. 6B illustrates a case where the steering angle sensor 10 is in failure. In FIG. 6A, V(FAST) represents a case where the vehicle speed V is greater than a predetermined threshold, and V(SLOW) represents a case where the vehicle speed V is less than the predetermined threshold. As can be seen from FIG. 6A, when the steering angle sensor 10 is normal, the steering angle θs changes proportional to the rotational angular velocity ωv. By contrast, as can be seen from FIG. 6B, when the steering angle sensor 10 is in failure, for example, due to a break in wire, the steering angle θs remains unchanged regardless of whether the steering angle θs actually changes.

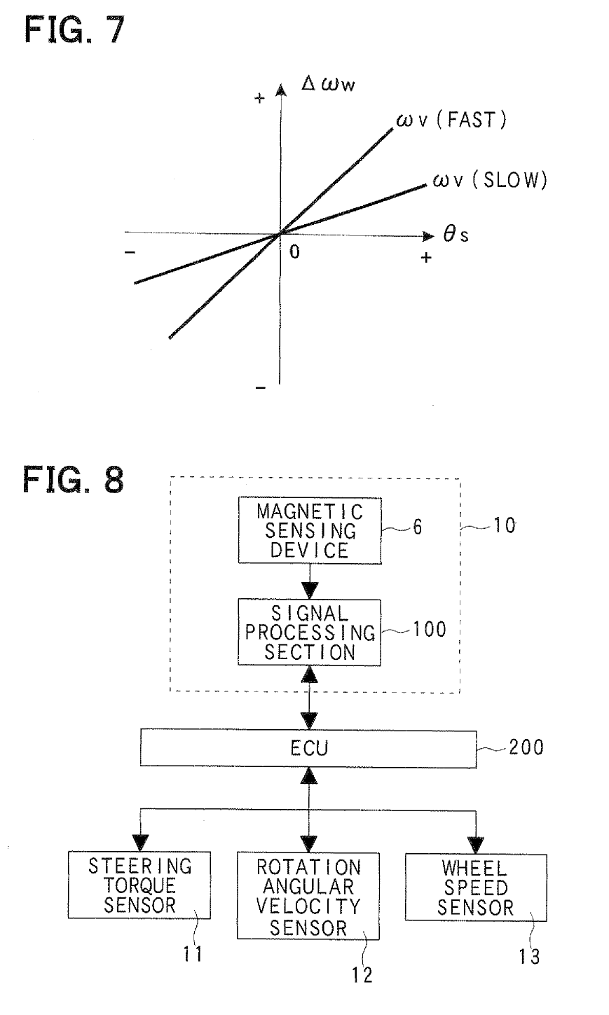

FIG. 7 illustrates a relationship between the steering angle θs, a wheel speed difference Δωw between right and left wheel speeds ωw, and the rotational angular velocity ωv. In FIG. 7, ωv(FAST) represents a case where the rotational angular velocity ωv is greater than a predetermined threshold, and ωv(SLOW) represents a case where the rotational angular velocity ωv is less than the predetermined threshold. As can be seen from FIG. 7, the steering angle θs changes proportional to the wheel speed difference Δωw.

In summary, it can be understood from FIGS. 6A and 7 that the steering angle θs has a continuous correlation with each of the steering torque Ts, the rotational angular velocity ωv, and the wheel speed ωw. Therefore, it can be determined whether the steering angle θs detected by the steering angle sensor 10 is invalid based on the correlations between these parameters. Specifically, when the detected steering angle θs has a deviation from each correlation by a predetermined value, it can be determined that the detected steering angle θs is invalid. Further, by using multiple sensors 11-13, it can be determined whether the steering angle sensor 10 is in failure or any one of sensors 11-13 is in failure.

The above determination process can be performed in S102. in such an approach, a failure of the steering angle sensor 10 can be detected with a simple structure.

As describe above, according to the embodiment, reliability of the steering angle θs, which is an important parameter when driving a vehicle, can be greatly improved with a simple structure.

(Modification)

The embodiments described above can be modified in various ways. For example, in the embodiment, the signal processing section 100 uses the detection signals received from three sensors 11-13 mounted on the vehicle. That is, each of the sensors 11-13 is used as a correlation signal output sensor for outputting a correlation signal correlated with the steering angle θs. Alternatively, at least one of the sensors 11-13 can be used as a correlation signal output sensor. Further, another sensor in addition to or instead of the sensors 11-13 can be used as a correlation signal output sensor.

In the embodiment, as shown in FIG. 4, the routine illustrated in FIG. 5 is performed by the signal processing section 100 incorporated in the steering angle sensor 10 so that the signal processing section can serve as a signal check circuit. That is, the signal check circuit is incorporated in the signal processing section 100. Alternatively, as shown in FIG. 8, the routine illustrated in FIG. 5 can be performed by an external circuit such as an electronic control unit (ECU) 200 located outside the steering angle sensor 10 so that the ECU 200 can serve as a signal check circuit. That is, the signal check circuit can be incorporated in the ECU 200 instead of the steering angle sensor 10. Since the ECU 200 generally receives outputs of such sensors 11-13 mounted on the vehicle, wiring can be simplified by using the ECU 200, compared to a configuration shown in FIG. 4.

In the routine illustrated in FIG. 5, the signal check circuit (the signal processing section 100 or the ECU 200) detects a failure of the steering angle sensor 10, when the steering angle θs is determined invalid once for a predetermined continuous period of time. Alternatively, the signal check circuit can detect a failure of the steering angle sensor 10, when the steering angle as is determined invalid two or more times for the predetermined continuous period of time so as to prevent the steering angle θs from being accidentally determined invalid, for example, due to a surge voltage applied to a power supply.

The signal check circuit can generate an alarm indicative of the failure of the steering angle sensor 10 upon detection of the failure of the steering angle sensor 10. For example, the alarm can be audible and/or visible for a driver.

The steering angle θs can be prohibited to be used for operation of a steering torque assist motor, when the steering angle θs has a large deviation.

Such changes and modifications are to be understood as being within the scope of the present invention as defined by the appended claims.

What is claimed is:

1. A steering angle sensor for detecting a steering angle of a steering shaft of a vehicle, the steering angle sensor comprising:
a magnetized body configured to provide a magnetic circuit with a gap, the magnetized body being coupled through a gear to the steering shaft so as to rotate on a magnet rotation axis in conjunction with rotation of the steering shaft;
a magnetic sensing device located on the magnet rotation axis to detect a magnetic field generated by the magnetized body, the magnetic sensing device outputting a magnetic field signal indicative of the magnetic field;
a signal processing device configured to detect a direction of the magnetic field based on the magnetic field signal and to detect the steering angle based on the direction of the magnetic field, the signal processing device outputting a steering angle signal indicative of the steering angle;
a correlation signal output sensor mounted on the vehicle to output a correlation signal correlated with the steering angle signal; and
a signal check circuit configured to determine whether the steering angle signal is valid or invalid based on comparison between the steering angle signal and the correlation signal.

2. The steering angle sensor according to claim 1, wherein
the signal check circuit detects a failure of the steering angle sensor when the steering angle signal is determined invalid at least once for a predetermined continuous period of time.

3. The steering angle sensor according to claim 2, wherein
the signal check circuit detects the failure of the steering angle sensor when the steering angle signal is determined invalid twice or more times for the predetermined continuous period of time.

4. The steering angle sensor according to claim 2, wherein
the signal check circuit generates an alarm indicative of the failure of the steering angle sensor upon detection of the failure of the steering angle sensor.
